(19) United States
(12) Patent Application Publication
(10) Pub. No.: US 2016/0170528 A1
(43) Pub. Date: Jun. 16, 2016

(54) CAPACITIVE TOUCH PANEL WITH SINGLE SENSING LAYER

(71) Applicant: ELAN MICROELECTRONICS CORPORATION, Hsinchu (TW)

(72) Inventors: Chia-Mu Wu, Taipei City (TW); Ting-Hsuan Cheng, New Taipei City (TW)

(73) Assignee: ELAN MICROELECTRONICS CORPORATION, Hsinchu (TW)

(21) Appl. No.: 14/936,660

(22) Filed: Nov. 9, 2015

(30) Foreign Application Priority Data
Dec. 11, 2014 (TW) 103143272

(51) Int. Cl. G06F 3/044; G06F 3/041

(52) U.S. Cl. CPC G06F 3/044; G06F 3/0416; G06F 2203/04103; G06F 2203/04112

(57) ABSTRACT

A capacitive touch panel with single sensing layer has a substrate. The substrate has the single sensing layer formed thereon. The sensing layer has multiple electrode sets. Each electrode set has multiple driving electrode rows and multiple receiving electrode rows arranged alternately. The multiple driving electrode rows of one electrode set have different driving electrodes, but different electrode sets have the same multiple driving electrode rows. The multiple receiving electrode rows of one electrode set are consisted of multiple same receiving electrodes, but different electrode sets have different receiving electrode rows. Therefore, using less contacts can also maintained the area and the solution so that the pins on the IC are also decreased. Thus, the volume of the IC is reduced and the packaging cost is also reduced.

### CROSS-REFERENCE TO RELATED APPLICATIONS

This application is based upon and claims priority under 35 U.S.C. 119 from Taiwan Patent Application No. 103143272 filed on Dec. 11, 2014, which is hereby specifically incorporated herein by this reference thereto.

### BACKGROUND OF THE INVENTION

1. Field of the Invention

The present invention relates to a capacitive touch panel with single sensing layer, especially to a touch panel as an input device for an electronic device.

2. Description of the Prior Arts

Capacitive touch panels with single sensing layer are widely used as input devices. With reference to FIG. 5, a conventional capacitive touch panel with single sensing layer has a sensing layer 40 mounted on one side of a substrate 50 and having multiple driving electrode rows and multiple receiving electrode rows alternately arranged along a first direction. The driving electrode rows and the receiving electrode rows are formed on the same surface. Each driving electrode layer has multiple driving electrode units arranged along a second direction, including a first driving electrode unit T1, a second driving electrode unit T2, a third driving electrode unit T3, a fourth driving electrode unit T4 and a fifth driving electrode unit T5. The driving electrode units of the driving electrode rows having the same serial number connect to the same contact. For example, the first driving electrode units T1 of each driving electrode row connect to the same contact, and the second driving electrode units T2 of each driving electrode row connect to the same contact. Each receiving electrode row has multiple receiving electrode unit arranged along the second direction. The first receiving electrode row has multiple first receiving electrode units R1 and multiple second receiving electrode units R2 arranged alternately. The first receiving electrode units R1 connect to each other and connect to the same contact. The second receiving electrode units R2 connect to each other and connect to the same contact. The adjacent receiving electrode rows have different receiving electrode units. For example, the first receiving electrode row has multiple first receiving electrode units R1 and multiple second receiving electrode units R2 while the second receiving electrode row has multiple third electrode units R3 and multiple receiving electrode units R4. Each driving electrode unit corresponds to two receiving electrode units to increase resolution in a limited area. If each driving electrode unit only corresponds to one receiving electrode unit, the capacitive touch panel can only provide the resolution of 5×8=40 pixels. However, as shown in FIG. 5, the conventional capacitive touch panel provides the resolution of 5×16=80 pixels in the same area by using each driving electrode unit corresponding to two receiving electrode units.

However, although the conventional capacitive touch panel increases the resolution, the contacts are also increased. For example, only thirteen contacts are needed when the resolution is 5×8=40 pixels, but twenty-one contacts are needed when the resolution is 5×16=80 pixels. More contacts need more leads on the integrated circuit (IC). When the leads are increased, the packaging cost and the volume of the IC is also increased. Therefore, the conventional capacitive touch panel still needs to be improved.

To overcome the shortcomings, the present invention provides a capacitive touch panel with single sensing layer to mitigate or obviate the aforementioned problems.

### SUMMARY OF THE INVENTION

An objective of the present invention is to provide a capacitive touch panel with single sensing layer reduces the amount of the contacts to decrease the volume and the manufacturing cost of the IC without increasing areas and losing resolution.

To achieve the aforementioned objective, the capacitive touch panel with single sensing layer comprises:

a substrate; and

n electrode sets formed on one side surface of the substrate, wherein an x-th electrode set comprises
i a-th electrodes including an a₁-th electrode, an a₂-th electrode . . . , to an aᵢ-th electrode; and
multiple bₓ-th electrodes including multiple bₓ₁-th electrodes, multiple bₓ₂-th electrodes . . . , to multiple bₓⱼ-th electrodes;

each electrode set comprising multiple electrode groups;

each electrode group having an a-th electrode column and a b-th electrode column;

the a₁-th electrode, the a₂-th electrode . . . , to the aᵢ-th electrode of the same electrode set arranged to compose the a-th electrode columns of the electrode groups of the same electrode set;

the b-th electrode column of each electrode group of each electrode set having the bₓ₁-th electrodes, the bₓ₂-th electrodes . . . , to the bₓⱼ-th electrodes arranged alternately;

the a-th electrode column and the b-th electrode column of each electrode group arranged adjacent to each other;

the a₁-th electrode to the aᵢ-th electrode of the same electrode set respectively connecting to different contacts; and

the bₓ₁-th electrodes to the bₓⱼ-th electrodes of the same electrode set respectively connecting to different contacts; and

the bₓ₁-th electrodes to the bₓⱼ-th electrodes of the different electrode sets respectively connecting to different contacts, wherein

the “n” is a positive integer equal or larger than two, the “i” is a positive integer equal or larger than two, the “j” is a positive integer equal or larger than two, and the “x” is anyone of positive integers between 1 to n.

The present invention has following advantages. Each set has the at least two rows of the a-th electrodes and the bₓ-th electrodes. With repeating the same bₓ-th electrodes in the same set, repeating the same a-the electrodes in different sets, and arranging different bₓ-th electrodes in different sets, the amount of the contacts is effectively reduced in the same area and touch panel still provides the same resolution. Therefore, the volume and the packaging cost of the IC are reduced.

In another aspect, the capacitive touch panel with single sensing layer comprises:

a substrate;

a sensing layer formed on a surface of the substrate and including multiple areas arranged along a first direction, and each area having
a first driving electrode unit and a second driving electrode unit arranged along a second direction and adjacent to each other;
a first receiving electrode unit and a second receiving electrode unit arranged on one side of the first driving electrode unit and the second driving electrode unit to form coupling capacitances;
a third driving electrode unit and a fourth driving electrode unit arranged along the second direction and adjacent to each other, and the third driving electrode unit approximately aligning with the first driving electrode unit along the first direction; and
a third receiving electrode unit and a fourth receiving electrode unit arranged on one side of the third driving electrode unit and the fourth driving electrode unit to form coupling capacitances; wherein

the first receiving electrode unit connecting to the third receiving electrode unit to form a first receiving electrode;

the second receiving electrode unit connecting to the fourth receiving electrode unit to form a second receiving electrode;

the first driving electrode units of the areas connecting to each other to form a first driving electrode;

the second driving electrode units of the areas connecting to each other to form a second driving electrode;

the third driving electrode units of the areas connecting to each other to form a third driving electrode;

the fourth driving electrode units of the areas connecting to each other to form a fourth driving electrode; and

the first, second, third and fourth driving electrode units and the first, second, third and fourth receiving electrode units of each area formed on the sane surface.

The present invention has following advantages. Each area has two rows of the driving electrode units. With repeating the same receiving electrodes in the same area, repeating the same driving electrodes in different areas, and arranging different receiving electrodes in different areas, the amount of the contacts is effectively reduced in the same area and touch panel still provides the same resolution. Therefore, the volume and the packaging cost of the IC are reduced.

Other objectives, advantages and novel features of the invention will become more apparent from the following detailed description when taken in conjunction with the accompanying drawings.

### BRIEF DESCRIPTION OF THE DRAWINGS

FIG. 1 is an illustrative view of a first embodiment of a capacitive touch panel with single sensing layer in accordance with the present invention;

FIG. 2 is an illustrative view of a second embodiment of a capacitive touch panel with single sensing layer in accordance with the present invention;

FIG. 3 is an illustrative view of a third embodiment of a capacitive touch panel with single sensing layer in accordance with the present invention;

FIG. 4 is an illustrative view of a fourth embodiment of a capacitive touch panel with single sensing layer in accordance with the present invention; and

FIG. 5 is an illustrative view of a conventional capacitive touch panel with single sensing layer in accordance with the prior art.

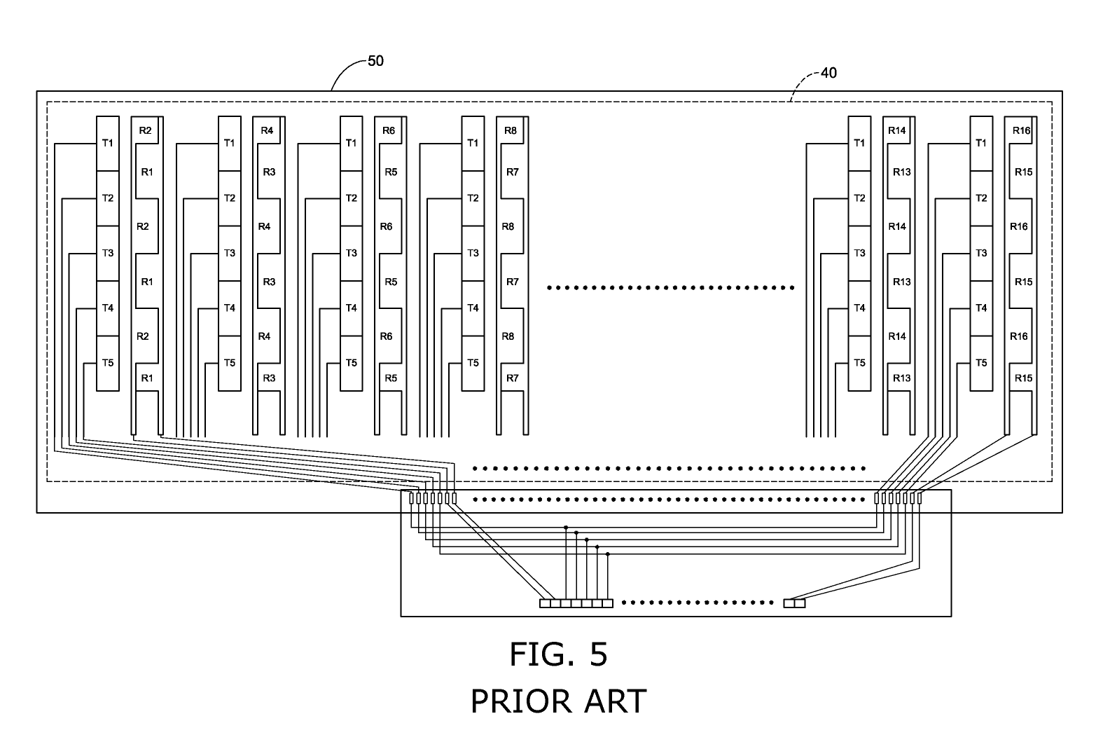

### DETAILED DESCRIPTION OF THE PREFERRED EMBODIMENTS

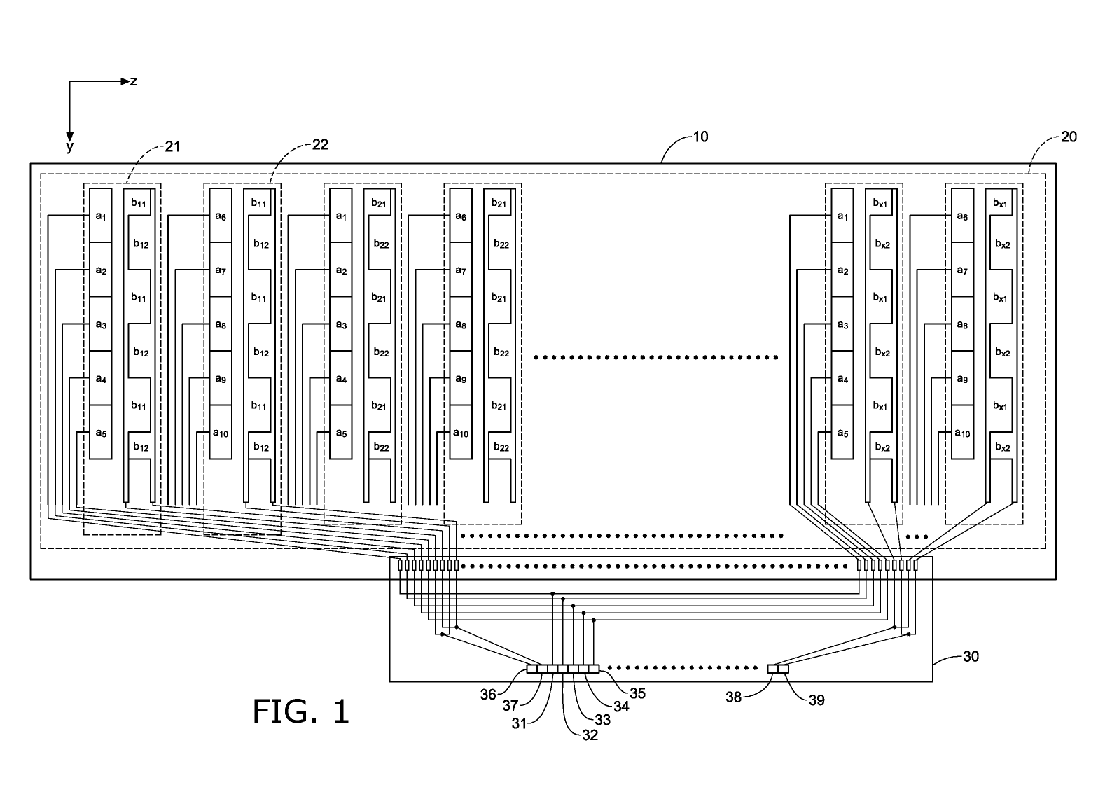

With reference to FIG. 1 a capacitive touch panel with single sensing layer in accordance with the present invention comprises a substrate 10 and a sensing layer 20. The sensing layer 20 is formed on one side surface of the substrate 10. The sensing layer 20 comprises n electrode sets. The electrode sets may be parallel to each other. The x-th electrode set comprises i a-th electrodes and multiple bₓ-th electrodes. The a-th electrodes include an a₁-th electrode, an a₂-th electrode . . . , to an aᵢ-th electrode. The bₓ-th electrodes include multiple bₓ₁-th electrodes, multiple bₓ₂-th electrodes . . . , to multiple bₓⱼ-th electrodes. For example, the first electrode set shown in FIG. 1 has the a-th electrodes including an a₁-th electrode, an a₂-th electrode . . . to an a₁₀-th electrode and the bₓ-th electrodes including multiple b₁₁-th electrodes and multiple b₁₂-th electrodes.

Each electrode set comprises multiple electrode groups. Each electrode group has an a-th electrode column and a b-th electrode column. Each a-th electrode column comprises multiple a-th electrodes. Each b-th electrode column comprises more than two bₓ₁-th electrodes, more than two bₓ₂-th electrodes . . . , to more than two bₓⱼ-th electrodes. For each electrode group, the a-th electrode column is arranged adjacent to the b-th electrode column. As shown in FIG. 1, the a₁-th electrode to a₅-th electrode are arranged in the first column while the b₁₁-th electrodes and the b₁₂-th electrodes are arranged in the second column alternately. A first electrode group 21 is composed of the first column and the second column. The a₆-th electrode to a₁₀-th electrode are arranged in the third column while the b₁₁-th electrodes and the b₁₂-th electrodes are arranged in the fourth column alternately. A second electrode group 22 is composed of the third column and the fourth column. One electrode set is composed of the first electrode group 21 and the second electrode group 22. Therefore, in the electrode groups of each electrode set, the a-th electrode columns of the electrode groups of each electrode set are composed of one a₁-th electrode to one aᵢ-th electrode. For example, the a-th electrode column of the first electrode group 21 comprises one a₁-th electrode to one a₅-th electrode, and the a-th electrode column of the second electrode group 22 comprises one a₆-th electrode to one a₁₀-th electrode. However, in the electrode groups of each electrode set, the b-th electrode columns comprises multiple bₓ-th electrodes. For example, the b-th electrode column of the first electrode group 21 and the b-th electrode column of the second electrode group 22 are both composed of multiple b₁₁-th electrodes and multiple b₁₂-th electrodes.

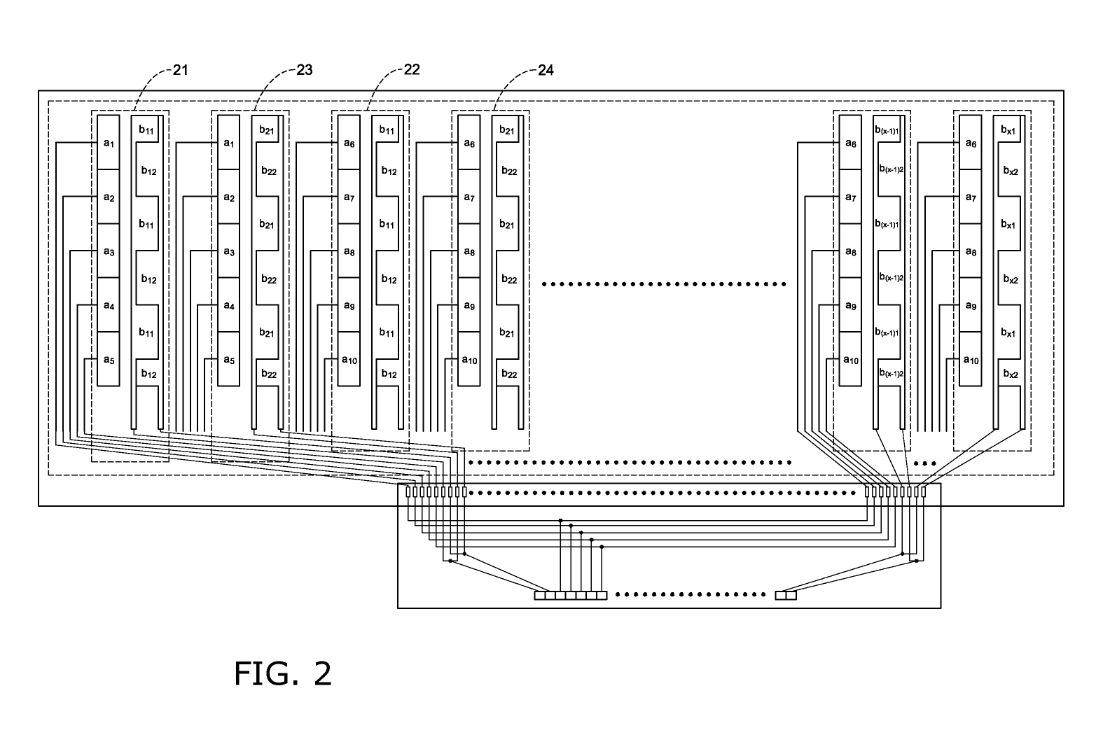

Each a-th electrode of the a-th electrode column corresponds to one bₓ₁-th to one bₓⱼ-th electrode. As shown in FIG. 1, in the first electrode set, each one of the a₁-th to a₁₀-th electrodes corresponds to one b₁₁-th electrode and one b₁₂-th electrode. In one embodiment, the electrode groups of each electrode set may be arranged adjacent to each other. As shown in FIG. 1, the first electrode group 21 of the first electrode set is arranged adjacent to the second electrode group 22 of the first electrode set. In another embodiment, the electrode groups of the adjacent electrode sets are arranged alternately. As shown in FIG. 2, the first electrode set is arranged adjacent to the second electrode set. The first electrode group 21 and the second electrode group 22 of the first electrode set and the third electrode group 23 and the fourth electrode group 24 of the second electrode set are arranged alternately. Thus, the first electrode group 21, the third electrode group 23, the second electrode group 22 and the fourth electrode group 24 are arranged in sequence.

The a₁-th electrode to the aᵢ-th electrode of the same electrode set respectively connect to different contacts. The aᵢ-th electrode of different electrode sets connect to the same i-th contact. As shown in FIG. 1, the a₁-th electrodes of the electrode sets are connected to a first contact 31 on a carrier 30. The a₂-th electrodes of the electrode sets are connected to a second contact 32 on the carrier 30. The a₃-th electrodes of the electrode sets are connected to a third contact 33 on the carrier 30. The a₄-th electrodes of the electrode sets are connected to a fourth contact 34 on the carrier 30. The a₅-th electrodes of the electrode sets are connected to a fifth contact 35 on the carrier 30, and so forth.

The bₓ₁-th electrodes to the bₓⱼ-th electrodes of the same electrode set are respectively connected to different contacts. The bₓ₁-th electrodes to the bₓⱼ-th electrodes of the different electrode sets are respectively connected to different contacts. As shown in FIG. 1, all of the b₁₁-th electrodes of the first electrode set are connected to the sixth contact 36 on the carrier 30. All of the b₁₂-th electrodes of the first electrode set are connected to the seventh contact 37 on the carrier 30. In other words, all of the bₓ₁-th electrodes of the x-th electrode set are connected to an x1-th contact 38 on the carrier 30. All of the bₓ₂-th electrodes of the x-th electrode set are connected to the x2-th contact 39 on the carrier 30.

In one embodiment, the “n” is a positive integer equal or larger than two. The “i” is a positive integer equal or larger than two. The “j” is a positive integer equal or larger than two. The “x” is anyone of positive integers between 1 to n.

Therefore, with the same area, the a-th electrode columns are repeated in two columns for different electrode sets and the b-th electrode columns are repeated in one column for the same electrode set. For 80 pixels, the a-th electrodes include a₁-th to a₁₀-th electrodes and the b-th electrodes include b₁₁-th to b₄₂-th electrodes so that ten a-th electrodes and eight b-th electrodes obtain 80 pixels and only eighteen contacts are needed in accordance with the present invention. As for the conventional capacitive touch panel to obtain 80 pixels, twenty-one contacts are needed. Therefore, the capacitive touch panel in accordance with the present invention effectively reduces the contacts, especially for high resolution. For 216 pixels, the conventional capacitive touch panel needs forty-two contacts including thirty-six a-th electrodes and six b-th electrodes, wherein the six a-th electrodes are arranged in the same column and each a-th electrode corresponds to the two bₓ-th electrodes. However, the capacitive touch panel in accordance with the present invention only needs thirty contacts for 216 pixels including twelve a-th electrodes and eighteen b-th electrodes, wherein the a-th electrodes are respectively arranged in two columns and each a-th electrode corresponds to the two bₓ-th electrodes. When the contacts are reduced, the leads on the IC are also decreased so that the volume and the packaging cost of the IC are also reduced.

In one embodiment, the a-th electrodes are designed as driving electrodes, and the excitation signals are transmitted to the a-th electrodes. The b-th electrodes are designed as receiving electrodes, and the sensing results are received from the b-th electrodes. In another embodiment, the a-th electrodes are designed as receiving electrodes and the b-th electrodes are designed as driving electrodes.

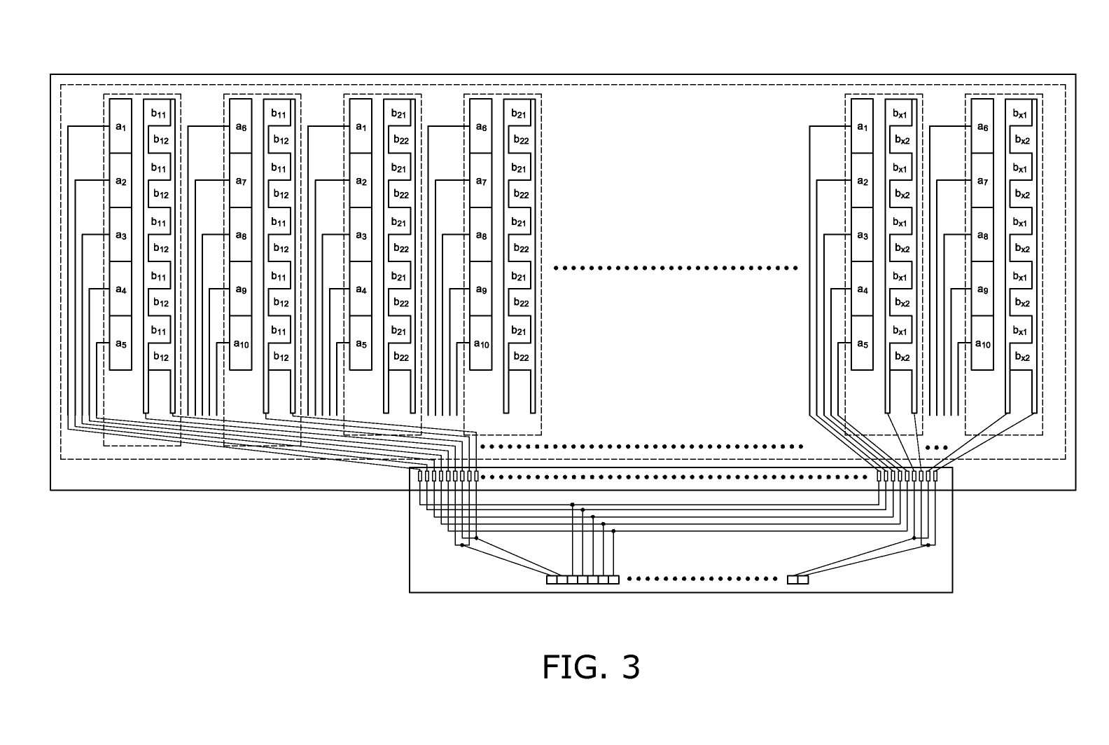

Further, the bₓ₁-th to bₓⱼ-th electrodes corresponding to the same one of the a-th electrodes may be arranged in sequence. As shown in FIG. 3, the b₁₁-th electrode and the b₁₂-th electrode corresponding to one of the a-th electrode are arranged in sequence.

Moreover, the adjacent bₓ-th electrodes of the same b-th electrode column corresponding to the adjacent a-th electrodes may be integrated into a single electrode so that the adjacent a-th electrode has common bₓ-th electrode to simplify the pattern of the sensing layer 20. As shown in FIG. 1, the second bₓ-th electrodes are the b₁₂-th electrodes, which are integrated as one electrode to simultaneously correspond to the a₁-th electrode and the a₂-th electrode.

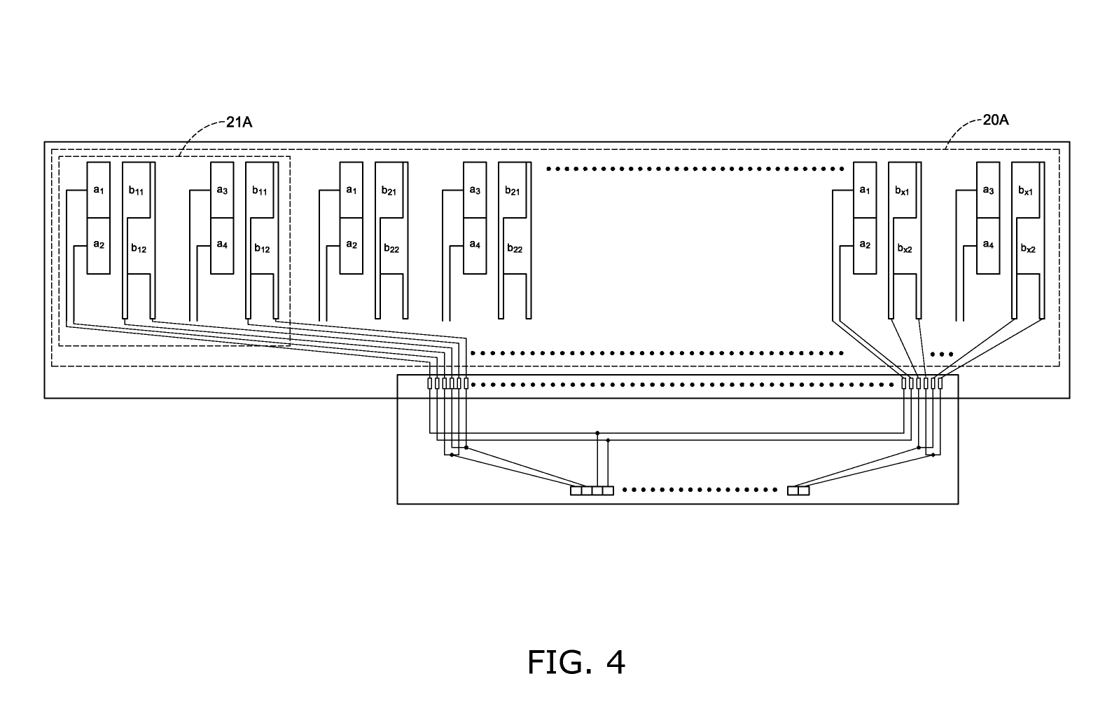

In another embodiment as shown in FIG. 4, the sensing layer 20A comprises multiple sensing areas 21A. Each sensing area 21A has four driving electrode units a₁, a₂, a₃, a₄ and two receiving electrodes b₁₁, b₁₂. The electrode sets are arranged along a first direction y and the electrode units in each column are arranged along a second direction z. For example, the driving electrode units a₁, a₂ are arranged in the first column along the second direction z and the receiving electrode units are arranged in the second column along the second direction z. The first column and the second column are arranged along the first direction y. The first receiving electrodes b₁₁ include a first receiving electrode unit and a third receiving electrode unit connecting to each other. The second receiving electrodes b₁₂ include a second receiving electrode unit and a fourth receiving electrode unit connecting to each other. The first receiving electrode unit and the second receiving electrode unit are arranged adjacent to the first driving electrode unit a₁ and the second driving electrode unit a₂ to form coupling capacitances. The third driving electrode unit a₃ and the fourth driving electrode unit a₄ approximately align with the first driving electrode unit a₁ and the second driving electrode unit a₂ along the first direction y. The third receiving electrode unit and the fourth receiving electrode unit are arranged adjacent to the third driving electrode unit a₃ and the fourth driving electrode unit a₄ to form coupling capacitances. Each receiving electrode unit may comprise multiple sub-receiving electrode units to form coupling capacitances with each driving electrode unit. With the aforementioned description, a person skilled in the art should understand that using more driving electrodes can achieve the effective to reduce contacts in different embodiments.

The first driving electrode units a₁ of each sensing area 21A are connected to each other to form a first driving electrode. The second driving electrode units a₂ of each sensing area 21A are connected to each other to form a second driving electrode. The third driving electrode units a₃ of each sensing area 21A are connected to each other to form a third driving electrode. The fourth driving electrode units a₄ of each sensing area 21A are connected to each other to form a fourth driving electrode. The first, second, third and fourth driving electrode units and the first, second, third and fourth receiving units of the sensing areas 21A are formed on the same surface.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A capacitive touch panel with single sensing layer comprising:
a substrate; and
n electrode sets formed on one side surface of the substrate, wherein an x-th electrode set comprises
i a-th electrodes including an a₁-th electrode, an a₂-th electrode . . . , to an aᵢ-th electrode; and
multiple bₓ-th electrodes including multiple bₓ₁-th electrodes, multiple bₓ₂-th electrodes . . . , to multiple bₓⱼ-th electrodes;
each electrode set comprising multiple electrode groups;
each electrode group having an a-th electrode column and a b-th electrode column;
the a₁-th electrode, the a₂-th electrode . . . , to the aᵢ-th electrode of the same electrode set arranged to compose the a-th electrode columns of the electrode groups of the same electrode set;
the b-th electrode column of each electrode group of each electrode set having the bₓ₁-th electrodes, the bₓ₂-th electrodes . . . , to the bₓⱼ-th electrodes arranged alternately;
the a-th electrode column and the b-th electrode column of each electrode group arranged adjacent to each other;
any one of the a-th electrode of the same a-th electrode column respectively corresponding to one bₓ₁-th electrode to one bₓⱼ-th electrode;
the a₁-th electrode to the aᵢ-th electrode of the same electrode set respectively connecting to different contacts; and
the bₓ₁-th electrodes to the bₓⱼ-th electrodes of the same electrode set respectively connecting to different contacts; and
the bₓ₁-th electrodes to the bₓⱼ-th electrodes of the different electrode sets respectively connecting to different contacts, wherein
the “n” is a positive integer equal or larger than two, the “i” is a positive integer equal or larger than two, the “j” is a positive integer equal or larger than two, and the “x” is anyone of positive integers between 1 to n.

2. The capacitive touch panel with single sensing layer as claimed in claim 1, wherein the a₁-th electrodes to the aᵢ-th electrodes of different electrode sets respectively connect to corresponding a₁-th contact to corresponding aᵢ-th contact.

3. The capacitive touch panel with single sensing layer as claimed in claim 1, wherein for those corresponding to each two adjacent a-th electrodes in the same column of each electrode set, the corresponding bₓ-th electrodes, which are adjacent to each other, are integrated in a single electrode.

4. The capacitive touch panel with single sensing layer as claimed in claim 2, wherein for those corresponding to each two adjacent a-th electrodes in the same column of each electrode set, the corresponding bₓ-th electrodes, which are adjacent to each other, are integrated in a single electrode.

5. The capacitive touch panel with single sensing layer as claimed in claim 1, the bₓ₁-th electrode to the bₓⱼ-th electrode corresponding to the same a-th electrode are arranged in sequence.

6. The capacitive touch panel with single sensing layer as claimed in claim 2, the bₓ₁-th electrode to the bₓⱼ-th electrode corresponding to the same a-th electrode are arranged in sequence.

7. The capacitive touch panel with single sensing layer as claimed in claim 1, wherein the electrode groups of each electrode set are arranged adjacent to each other.

8. The capacitive touch panel with single sensing layer as claimed in claim 2, wherein the electrode groups of each electrode set are arranged adjacent to each other.

9. The capacitive touch panel with single sensing layer as claimed in claim 1, wherein the electrode groups of each two adjacent electrode sets are arranged alternately.

10. The capacitive touch panel with single sensing layer as claimed in claim 2, wherein the electrode groups of each two adjacent electrode sets are arranged alternately.

11. The capacitive touch panel with single sensing layer as claimed in claim 1, wherein the a-th electrodes are driving electrodes and the bₓ-th electrodes are receiving electrodes.

12. The capacitive touch panel with single sensing layer as claimed in claim 2, wherein the a-th electrodes are driving electrodes and the bₓ-th electrodes are receiving electrodes.

13. The capacitive touch panel with single sensing layer as claimed in claim 1, wherein the a-th electrodes are receiving electrodes and the bₓ-th electrodes are driving electrodes.

14. The capacitive touch panel with single sensing layer as claimed in claim 2, wherein the a-th electrodes are receiving electrodes and the bₓ-th electrodes are driving electrodes.

15. The capacitive touch panel with single sensing layer as claimed in claim 1, wherein the electrode sets are parallel to each other.

16. A capacitive touch panel with single sensing layer comprising:
a substrate;
a sensing layer formed on a surface of the substrate and including multiple areas arranged along a first direction, and each area having
a first driving electrode unit and a second driving electrode unit arranged along a second direction and adjacent to each other;
a first receiving electrode unit and a second receiving electrode unit arranged on one side of the first driving electrode unit and the second driving electrode unit and coupled respectively to the first driving electrode unit and the second driving electrode unit;
a third driving electrode unit and a fourth driving electrode unit arranged along the second direction and adjacent to each other, and the third driving electrode unit approximately aligning with the first driving electrode unit along the first direction; and
a third receiving electrode unit and a fourth receiving electrode unit arranged on one side of the third driving electrode unit and the fourth driving electrode unit and coupled respectively to the third driving electrode unit and the fourth driving electrode unit; wherein
the first receiving electrode unit connecting to the third receiving electrode unit to form a first receiving electrode;
the second receiving electrode unit connecting to the fourth receiving electrode unit to form a second receiving electrode;
the first driving electrode units of the areas connecting to each other to form a first driving electrode;
the second driving electrode units of the areas connecting to each other to form a second driving electrode;
the third driving electrode units of the areas connecting to each other to form a third driving electrode;
the fourth driving electrode units of the areas connecting to each other to form a fourth driving electrode; and
the first, second, third and fourth driving electrode units and the first, second, third and fourth receiving electrode units of each area formed on the sane surface.

17. The capacitive touch panel with single sensing layer as claimed in claim 16, wherein each receiving electrode unit comprises multiple sub-electrodes, and the sub-electrodes of each receiving electrode unit correspond to one of the driving electrode units.
